(19) United States
(12) Patent Application Publication
(10) Pub. No.: US 2003/0055881 A1
(43) Pub. Date: Mar. 20, 2003

(54) Method and apparatus for transmitting data over a network

(76) Inventor: Kim Cuc Ngo, Pleasanton, CA (US)

Correspondence Address: Brian R. Coleman, Patent Attorney, Perkins Coie LLP, 101 Jefferson Drive, Menlo Park, CA, 95025-1114, US

(21) Appl. No.: 10/035,140

(22) Filed: Dec. 19, 2001

Related U.S. Application Data
(60) Provisional application No. 60/322,595, filed on Sep. 14, 2001.

(51) Int. Cl. G06F 15/16

(52) U.S. Cl. 709/203

(57) ABSTRACT

A method of operation for a system for transmitting and receiving data within a network comprising dividing a file into its dynamic data components and static data components by comparing at least one expiration parameter corresponding to each component to a set setting a threshold, transmitting a request for a file form an intelligent client, receiving the file request by an intelligent server, transmitting at least the dynamic data components of the requested file to the intelligent client, and recreating by the intelligent client, the requested file by recombining the static components and the dynamic components of the requested file.

### CROSS REFERENCE TO RELATED APPLICATION

Reference is made and priority claimed to U.S. Provisional Application entitled METHOD AND APPARATUS FOR TRANSMITTING DATA OVER A NETWORK, filed Sep. 14, 2001, bearing application No. 60/322,595. Also this patent application is related to U.S. patent application Ser. No. 09/709,948 entitled METHODS FOR PROVIDING VIDEO-ON-DEMAND SERVICES FOR BROADCASTING SYSTEMS, filed Nov. 10, 2000, U.S. patent application Ser. No. 09/584,832 entitled NON CLIENT SPECIFIC ON-DEMAND DATA BROADCAST (As Amended), filed May 31, 2000. Each of the above referenced applications are hereby incorporated by reference herein.

### BRIEF DESCRIPTION OF THE INVENTION

1. Field of the Invention

The present invention relates to network data transmission systems and more particularly to methods of file transmission over a network.

2. Background of the Invention

The Internet has expanded greatly since the beginning of the 1990's and Internet traffic continues to grow exponentially as more users and newer uses are being added to this worldwide system everyday. Simple text file transfers have been replaced by sophisticated web pages including music, graphics, animation and video clips.

Increasing traffic on a network such as the Internet, along with larger file sizes has resulted in increasingly greater traffic congestion and longer access and download times.

One solution for the reducing the network congestion problems has been a brute force approach. Faster communications devices and better transmission mediums such as coaxial cable and optical lines have been used to increase the bandwidth and efficiency of the network systems. However, replacing existing cables and networking equipment with higher bandwidth and more efficient systems is costly. Furthermore, the rate of increase in network traffic is surpassing the rate at which technological improvements are being introduced.

Another limitation of the standard network communication model is that each client requires its own bandwidth. Thus, the total required bandwidth is directly proportional to the number of users. Cache memory within some local servers such as proxy servers have been used to improve bandwidth limitations but using cache memory does not solve the problem because cache memory is also limited.

Thus it is desirable to provide a system that is capable of improving network efficiency and freeing up available bandwidth, without expensive hardware improvements.

### SUMMARY OF THE INVENTION

Briefly, one aspect of the present invention is embodied in a method of operation for a system for transmitting and receiving data within a network comprising dividing a file into its dynamic data components and static data components by comparing at least one expiration parameter corresponding to each component to a set setting a threshold, transmitting a request for a file from an intelligent client, receiving the file request by an intelligent server, transmitting at least the dynamic data components of the requested file to the intelligent client, and recreating by the intelligent client, the requested file by recombining the static components and the dynamic components of the requested file.

Another aspect of the present invention is embodied in a method of parsing a data file into its static and dynamic components, comprising setting a threshold value for separating static and dynamic data components, obtaining expiration parameters for each portion of a data file, comparing each expiration parameter to the threshold value, identifying as dynamic data the portions of the data file that have an expiration value lower than the threshold value, and identifying as static data the portions of the data file that have an expiration value higher than the threshold.

Another aspect of the present invention is embodied in a method of sending requested data to a client from an intelligent file server, comprising receiving a request for a file from a client, the file including static data components and dynamic data components, determining whether a client is intelligent, creating static data packets containing static data components and separate dynamic data packets containing dynamic data components, and transmitting static data components and dynamic data to the intelligent client.

Another aspect of the present invention is embodied in a method for processing data received from an intelligent server comprising, sending a request for a file from an intelligent client, over a network, to an intelligent server, receiving static data packets and dynamic data packets separately, reconstructing the requested file from its static data packets and its dynamic data packets.

Another aspect of the present invention is embodied in a method of creating an intelligent protocol data packet comprising, including identifying information identifying the intelligent data protocol.

Another aspect of the present invention is embodied in a method for transmitting data over a network comprising, requesting a file from a server connected to a network by a client connected to a network via a network connection provider system, capturing the file request by the server providing the network connection, checking a memory cache related to the network connection provider for the presence of a first saved data relating to the requested file, sending static data saved on the cache memory, sending a request to the server for all data not saved on the cache memory, transmitting all data not saved on the cache memory to the network connection provider, transmitting all data not saved on the cache memory to the client, and reconstructing the requested file from static data and dynamic data.

### BRIEF DESCRIPTION OF THE DRAWINGS

Prior art FIG. 1 illustrates a traditional web Internet system;

Prior art FIG. 2 is a flow diagram for the processes of transmitting a file over the Internet;

Prior art FIG. 3 is a representation of a packet under a TCP/IP protocol;

Prior Art FIG. 4 is a representation of web page level interactions between a client and a server;

FIG. 5 is an illustration of a data transmission system according to one embodiment of the present invention;

FIG. 6 is a flow diagram of the operation of one embodiment of the new data transmission system;

FIG. 7 shows the new technology server of the system of FIG. 1 in more detail according to one embodiment of the present invention;

FIG. 8 is a flow chart for the operation of one embodiment of an intelligent data server;

FIG. 9 is an illustration of one embodiment of an intelligent ISP server;

FIG. 10 is a flow diagram of the operation of one embodiment of an intelligent ISP server;

FIG. 11 is an illustration of one embodiment of an intelligent client;

FIG. 12 is a flow diagram of the operation of one embodiment of the intelligent client;

FIG. 13 illustrates the static and dynamic data content of a typical file;

FIG. 14 is a flow diagram for the process of dividing a data file into its dynamic and static components for one embodiment of the present invention;

FIG. 15 illustrates a data packet according to one embodiment of the present invention;

FIG. 16 is a flow diagram of the operation of a system based on one embodiment of the present invention.

### DETAILED DESCRIPTION OF THE INVENTION

Prior art FIG. 1 illustrates a traditional Internet web system. Referring to FIG. 1, a series of users “user1” 12 to “user N” 14 are connecting to the Internet through Internet Service Providers (ISP). A typical private user such as “user1” may connect to the Internet through the IPS servers 16, or 20. Business users may connect to the Internet through their intranet network and may pass through firewalls and/or proxy servers. Alternatively, users belonging to proprietary ISPs such as America Online or Prodigy may direct requests from their subscribers through a gateway and possibly a proxy server connecting their intranet to the Internet. In each case a user makes a request 13 for a web page. The request 13 travels through various intermediate routers 24 and 28, and various links (e.g. satellite links) such as shown by 32 and 36 before reaching its final destination. Normally, the final destination is the web server 40 hosting the requested web page, where the web server responds to the user's request by sending the requested web page and/or the corresponding information to the user.

The Internet is primarily based on a packet switching technique. In packet switching technique, a large file is parsed into smaller size packets. Each packet includes a header containing information such as the destination of the packet, its source and an identification number. Each packet may be transmitted via a different route, independent of the others. Once the all the packets arrive at the destination, they are reassembled based on the ordering information within the header.

The response 42 of the web server 40 will be routed via different routes based on the level of congestion in the system and the value of parameters of various routes. Newer routers using the Open Shortest Path First (OSPF) protocol are able to check a variety of parameters such as the number of hops, delay, capacity, throughput, and reliability of the circuit connecting the routers, in order to select the route by which to send the data. The response from the web server 40 may have to be channeled through the Internet via multiple routers 26 and 30, and possible links 34 and 38 to the ISP servers 18 and 22 for each user 12 and 14.

In some cases, when private networks are connected to the Internet through a proxy server, the proxy server 18 or 22 may at least temporarily cache the most requested web pages in order to avoid using the Internet to get these web pages from the web server 40.

Prior art FIG. 2 is flow diagram for the processes of transmitting a file over the Internet. At block 44, a web server receives a file request from a client. At block 46, the web server retrieves the file from its cache memory, breaks the file into appropriately sized packets according to a TCP/IP protocol, and transmits the individual packets over the Internet. The term Cache memory as used here refers to temporary storage on a hard disk, RAM memory or any other type of memory that may be used to store data on a temporarily. At block 48, a client receives all the packets transmitted to it over the Internet, and does an error check to see if all the packets have been received. At block 49, if all the packets for a given file have not been received, the client sends a second request for the particular packets. At block 50, the client sends an acknowledgment for each packet that it has received. At block 52, after all the packets have been received, the packets are reassembled to construct the requested file.

Prior art FIG. 3 is a representation of a packet under a TCP/IP protocol. Data 58 transmitted over the Internet is encapsulated according to the IP protocol prior to transmission. Headers and trailers are added to each data packet giving information about the content of the packet. The encapsulation of the data 58 in a header and trailers forms a frame and is similar to placing a letter in an envelop before mailing. However, in the case of a frame, the packet 58 is encapsulated with information necessary for routing the packet such as the origination address and destination address. Furthermore, additional data is included in the header or tail concerning various parameters such as the packet length, checksum for verifying errors occurring during transmission, and the order of the packets necessary for reassembly once the packets arrive at their destination.

Referring back to FIG. 3, a header 54 is added to the data packet providing the information necessary based on the network layer Internet Protocol (IP) layer. Similarly, the Transport layer protocol TCP requires the addition of a header and/or tail to the packet prior to transmission. The IP layer only handles the routing of the packets 58 but it does not guarantee any the delivery of the packet and simply discards any data packets if problems occur. The Transmission Control Protocol (TCP) provides a considerable number of services to the IP layer as well as the layers above the TCP layer. Most importantly, the TCP layer provides a connection-oriented protocol that enables an application to know that a packet sent over the Internet is received in its entirety at the destination. TCP receives messages from the destination acknowledging the receipt of a complete file and ensuring that the transmission was complete. Furthermore, the TCP communicates with the applications in the upper layers as well as the network systems below it such as the IP layer. In prior art FIG. 3, additional header and tail data 56 are added by the TCP layer to the packet, before transmission.

Prior Art FIG. 4 is a representation of web page level interactions between a client and server. The client computer 60 may be running a web browser 62 such as the Microsoft® Internet Explorer® or Netscape® Navigator®. Typically, a web browser 62 assembles and displays the files sent from the server 66 to the client 60 upon the request issued by the client computer 60. The client computer 60 connects to the desired server 66 using a Universal Resource Locator (URL) that acts as an address useful in locating the server 66. One of the most popular protocols used is the Hyper Text Transfer Protocol (HTTP) used on the World Wide Web (www). Other URL protocols such as the File Transfer Protocol (FTP) may be used to retrieve files over a network, such as the Internet. In the example of FIG. 4, using an HTTP URL, the client computer 60 sends a request to the server 66 for a Hyper Text Markup Language (HTML) file, namely a HTML web page 64. Once the web browser 62 has received all the packets for the file comprising the HTML web page 64, it assembles the web page and displays it on the client's computer monitor. Additional plug-in programs 65 may be operating with the web browser 62 to perform operations a basic web browser may not be able to perform.

The server 66 may be using a web server such as the Microsoft™ IIS web server 68 as its web server running on a Windows NT Server 68 operating system. The HTML file 64 the client has requested may include static HTML pages 72 as well as special programs such as animated graphics 74 or movies on the user's computer that would be downloaded to the client and run there using special plug-in programs 65.

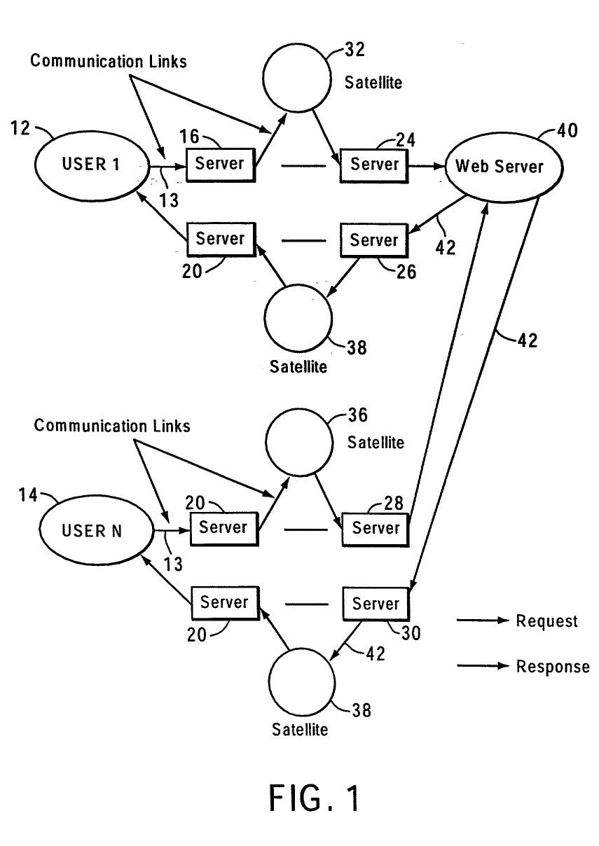

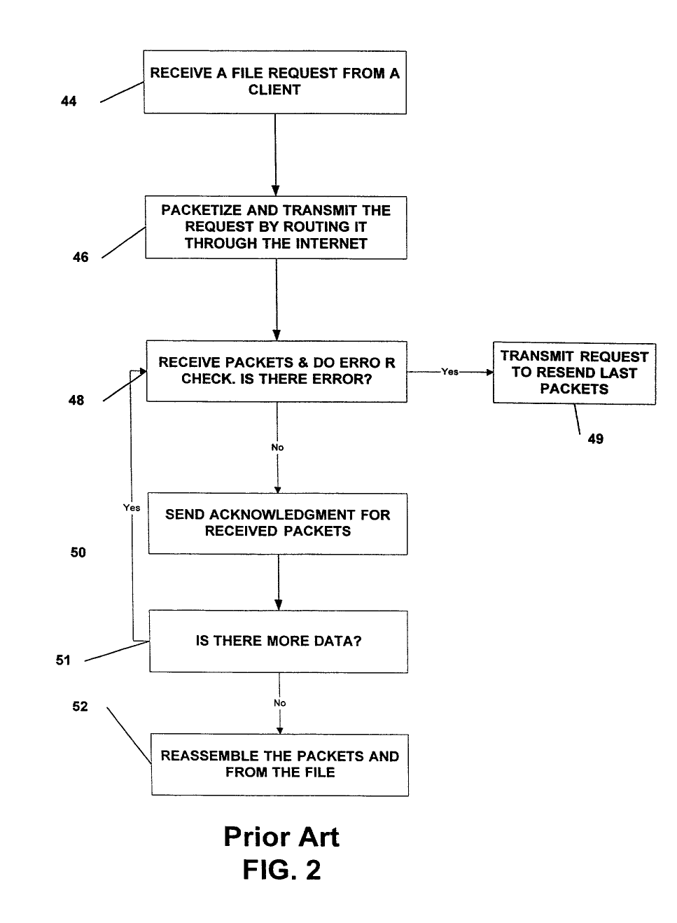

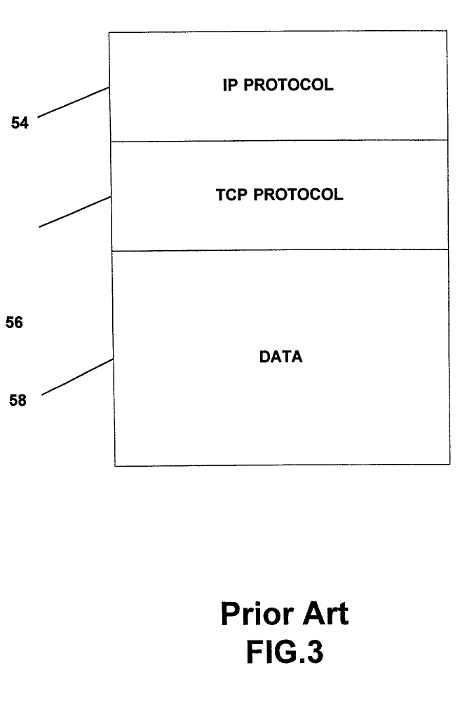

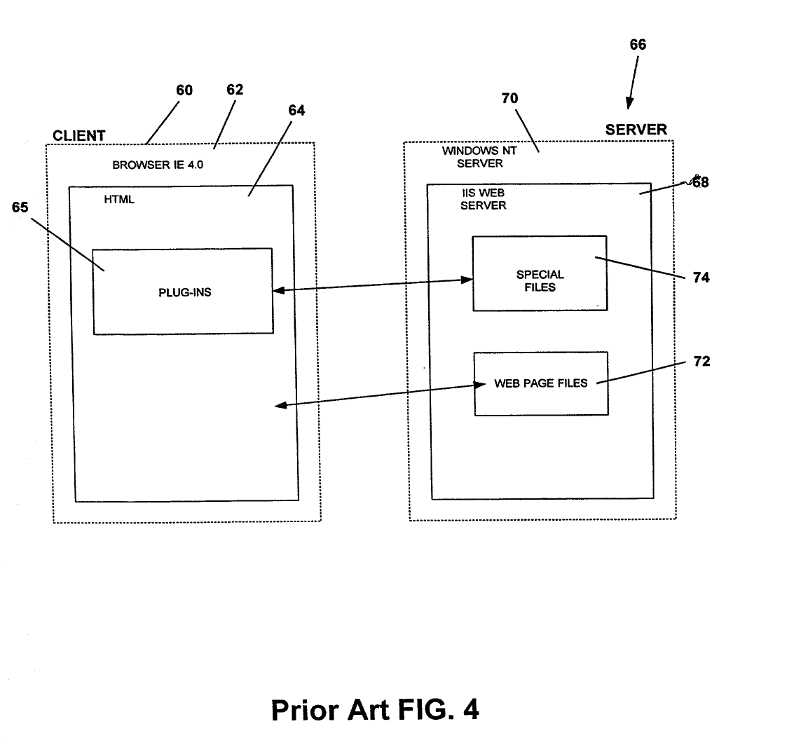

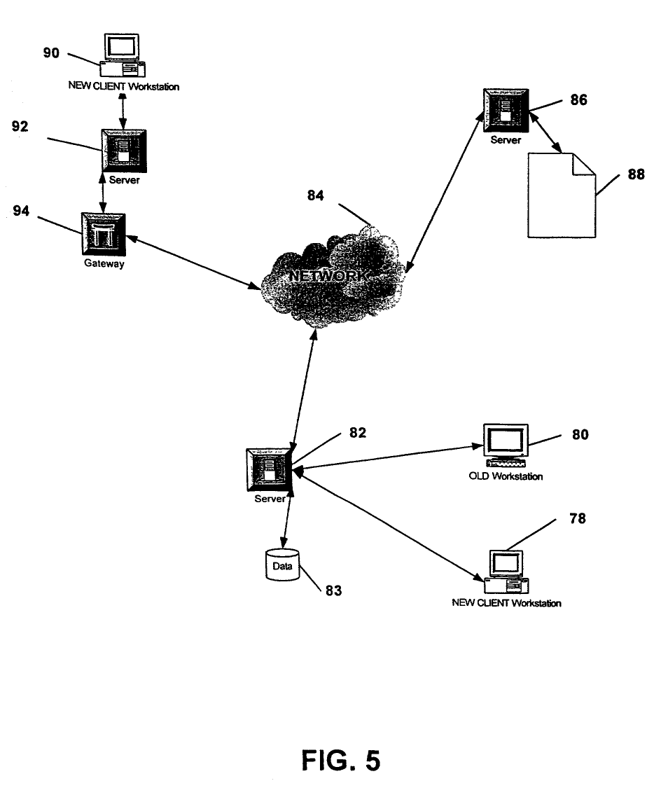

FIG. 5 is an illustration of a data transmission system according to one embodiment the present invention. Client A 78 and client B 80 send requests for data through the Internet Service Provider server 82 and the network 84 to the server 86 that has the requested file 88. Client N 90 may be part of a private network 92. Client N 90 may use the private network 92 and the public network 84 to send its file requests to the server 86. The private network 92 may be connected to the public network 84 and protected from it by a firewall and/or proxy server 94.

Client A 78 may include a new technology browser that allows client A 78 to receive and process packets are formed based on the new protocol. Client B may have an old technology browser and would have to receive packets based on the old protocol in order to process and reassemble the packets it receives. The ISP server 82 may also be a new technology server capable of receiving, processing and transmitting packets based on the new protocol. Additionally, an intelligent ISP server 82 may include cache memory 83 that might be used to store the static data portions of the most requested data files. As used herein, the term “intelligent” machine, such as an intelligent server, or an intelligent ISP or an intelligent client refers to a machine that is capable of processing a data file that may be divided up into its time sensitive (dynamic) and time insensitive (static) data parts. Processing may include parsing a data file into its components, transmitting, receiving, and reassembling the data file. In contrast, the term “non-intelligent” as used herein in this document refers to a client, file server or intermediate node server such as an ISP sever that is based on the current state of the art technology and does not parse data into its static and dynamic components.

The public network 84 may still operate based on the existing protocol. In one embodiment, the public network 84 may the Internet and the governing protocol may be the TCP/IP protocol. However, it should be noted that the teachings of the present invention are not limited to a particular protocol and/or a particular network type.

The server 86 is a new technology server capable of classifying, separating and processing data files into their dynamic and static components. A file 88 residing on the server 86 may be divided into dynamic data and static data components by the server software.

The distinguishing characteristic between dynamic data and static data is based on the definition that dynamic data is client specific, and static data is considered to be non-client specific data. Static data content changes at such a slow rate that the server can treat it as static or constant. In contrast, dynamic data content changes so rapidly that the server must handle it as variable data.

It should be noted that the definition of static and dynamic data is relative. A threshold may be set to separate dynamic data from static data. That is data with a rate of change greater than a set threshold may be treated as dynamic, whereas data with a rate of change below a certain rate may be treated as static data.

In the example of a web page file, the web designer may include in its design expiration dates for data comprising various parts of the web page. Things such as banners, logos, background and some text may remain have an expiration date set from days to months. On the other hand, if the web page includes a table of real time market stock values, the constantly changing stock values may have expiration dates of several seconds. In this example, if the web server threshold is set at one minute, any data within the web page file that has an expiration date of greater than one minute may be classified as static data. At the same time, any data such as the stock values with expiration dates less than one minute will be treated as dynamic value.

In one embodiment, the threshold value of the server 86 may be adjusted based the level of service requested from the server. The lower the threshold value, the greater the amount of static data and the less work there would be for the server.

Client N 90 and the ISP server 94 may also have new technology software and be capable of receiving and processing packet packets based on the new protocol.

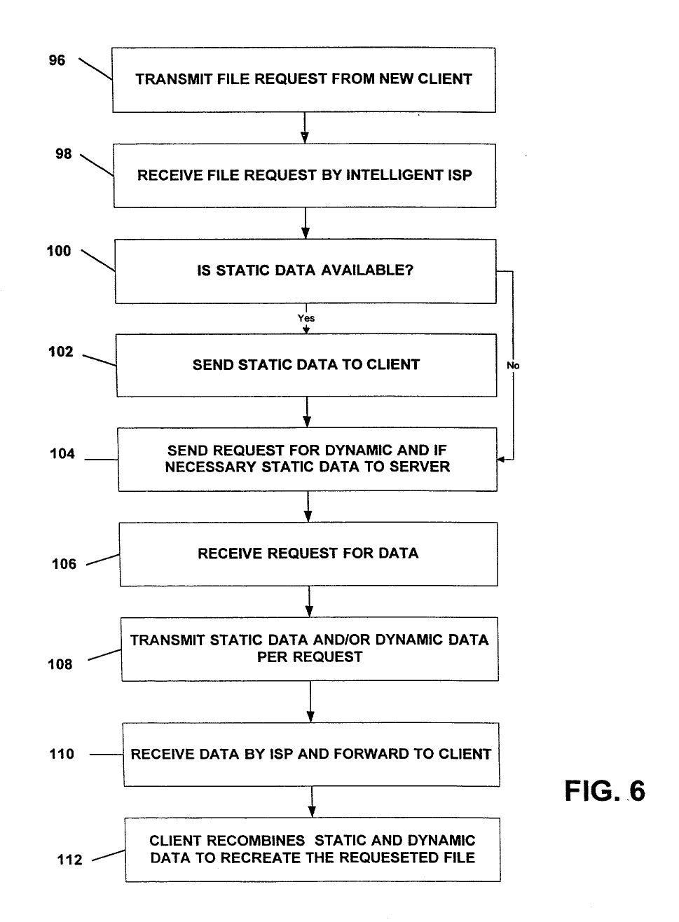

FIG. 6 is a flow diagram of the operation of one embodiment of the new data transmission system. At block 96, a file request is transmitted by new technology client such as client A 78 (see FIG. 5) to the new technology server 86. At block 98, the file request is routed through an ISP sever. If the ISP server is an intelligent server such as ISP server 82 (see FIG. 5), the ISP server may process the request initially. At block 100, the intelligent ISP server 82 checks its cache memory 83 to see if it is storing the static data relating to the requested file. If the cache memory 83 does have the static data for the particular file requested, the ISP server might transmit the static data to the client 78, at block 102. If the static data for the requested file is not available at the cache memory 83, the ISP server transmits a request for the static and dynamic data for that file, at block 104. If the static data was stored at the cache memory 83, a request for the dynamic portion of the data is transmitted to the server 86.

If the static data is available on the cache memory, the ISP server might directly send the requested static data to the requesting client. However, this transmission method requires increasing bandwidth as the number of clients placing a request for the given data increases.

In one alternative embodiment, the static data available is broadcast over the network to the multitude of requesting clients. In an alternative embodiment, the available static data is multicast to the requesting clients. In an exemplary embodiment, at the file server 86 side, sending data to a client to provide data-on-demand services using a method of multicasting can be achieved through the steps comprising of: receiving a data file, specifying a time interval, parsing the data file into a plurality of data blocks based on the time interval such that each data block is displayable during the time interval, determining a required number of time slots to send the data file, allocating to each time slot at least a first of the plurality of data blocks and optionally one or more additional data blocks, such that the plurality of data blocks is available in sequential order to a client accessing the data file during any time slot, and sending the plurality of data blocks based on the allocating step.

In one embodiment, the parsing step includes the steps of: determining an estimated data block size, determining a cluster size of a memory in a channel server, and parsing the data file based on the estimated data block size and the cluster size. In another embodiment, the determining step includes the step of assessing resource allocation and bandwidth availability.

At block 106, intelligent server 86 receives a request for data. As discussed above, the request may be for both static and dynamic data or only for the dynamic portion of the data. At block 108, the server 86 transmits the static and/or dynamic data based on the request it received. At block 110, once the ISP server 82 receives the transmitted data from the intelligent server 86, it forwards the data to the requesting client 78. At block 112, the requesting client assembles the static and dynamic data to recreate the file it has requested.

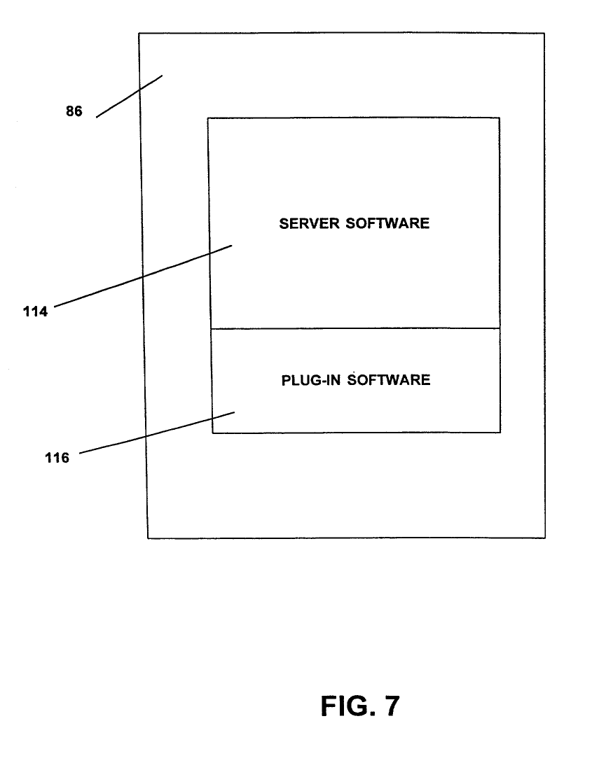

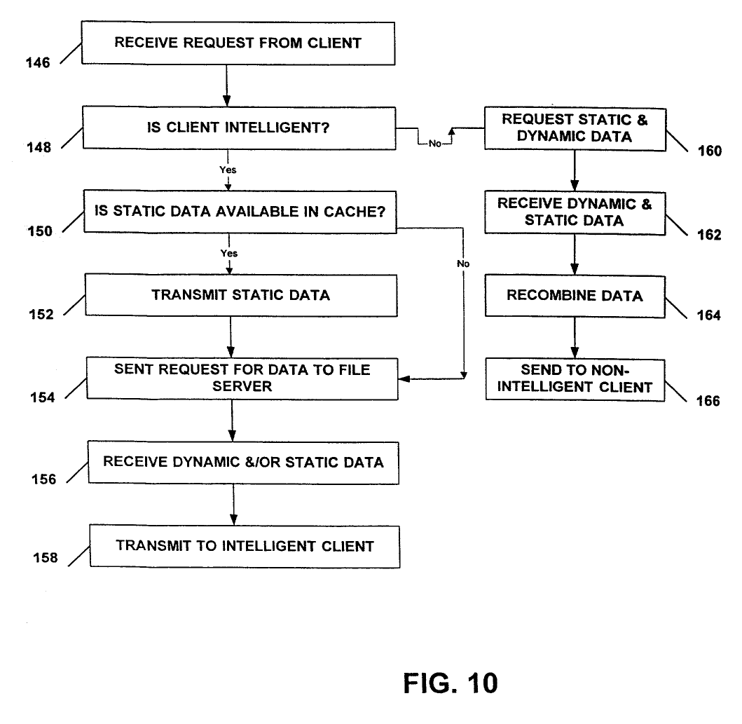

FIG. 7 is a new technology server according to one embodiment of the present invention. In one embodiment of the server 86, a server software 114 compliant with the existing protocol may comprise the basic operating software of the server. However, the add-on server software 116 may be providing the additional capabilities necessary to classify static and dynamic data, parse a file into its static and dynamic components, packetize packets of appropriate size based on existing network protocols, while including header or trailer information allowing the identification of the new packets comprising the static and dynamic data. The format of a packet for use in the invention is described further in FIG. 10.

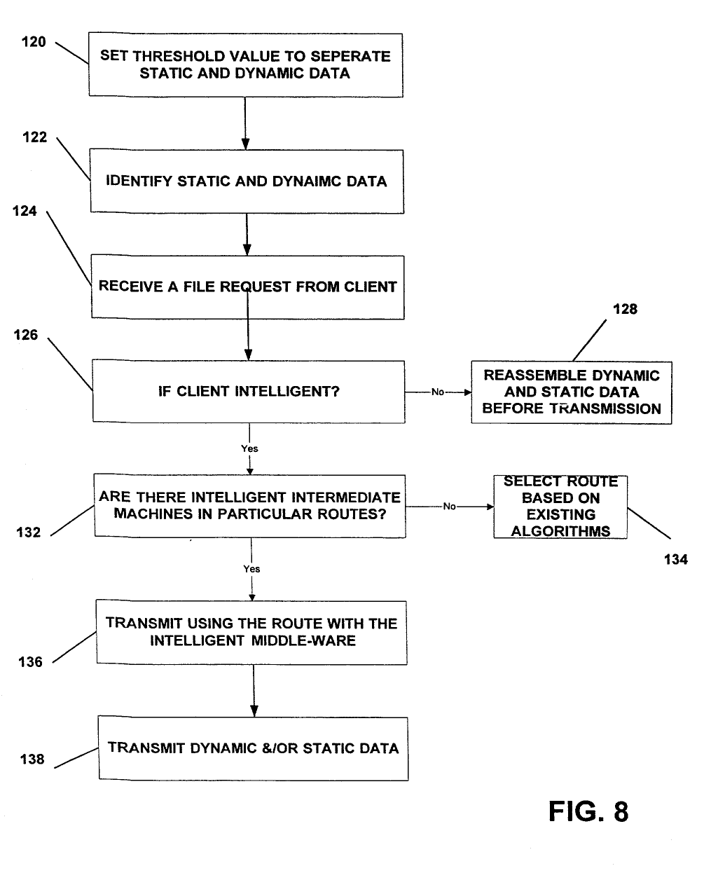

FIG. 8 is a flow chart for the operation of one embodiment of an intelligent data server. At block 120, the intelligent server 86 may set a threshold value based upon which the dynamic and static data classification may be made. In one embodiment, the value of threshold may be adjusted based on the performance requirements of the web server. A lower threshold value may be used to reduce the operating burden of the intelligent server 86 by classifying a larger portion of each file as comprising of static data and requiring less frequent retransmission. At block 122, the intelligent server 86 parses the files residing in its file storage database into their dynamic and static data components based on the set threshold value. At block 124, the intelligent file server 86 receives a request from a client machine. The term intelligent file server as used herein refers to a file server capable of parsing a data file into its static and dynamic components, by setting a threshold value, and comparing each data file component having an expiration parameter to the threshold, and separating the file into its static and dynamic data based on whether a file component expiration parameter value is greater than the threshold value or less. Once the intelligent server 86 has received a request, it may ascertain whether the request came from an intelligent client at block 126. In one embodiment, at block 128, if the request came from a traditional client, and there are no intelligent intermediate machines along any path between the intelligent server and the traditional client, then the server 86 recombines the dynamic and static portions of the requested file transmits the entire requested file based on the old network protocol. In one embodiment, the file server 86 may be a web server, the network may be the Internet and the applicable protocol may be the TCP/IP protocol.

At block 132, the intelligent web server determines whether there are intelligent intermediate machines such as intelligent ISPs along a particular route between the intelligent web server and the intelligent client. In one embodiment of the present invention, the intelligent server 86 may preferably use the route that includes at least one other intelligent device when sending its packets. In one embodiment, the determination of the presence of intelligent devices along a possible link of the route to the client is determined by using an address resolution table that includes additional fields indicating the whether an intelligent device may be present at that address. At block 134, if there are no intelligent intermediate machine along the route from the server 86 to the client 78, the server 86 may select the route based on such parameters as the congestion of the route, the number of hops, and so on.

A block 136, the intelligent web server may route the response to a first request form a client via a route including at least one intelligent intermediate device.

At block 138, if the original requester is an intelligent device, or if there are intermediate intelligent devices along the route from the intelligent server and the original client, the intelligent server transmits static data and dynamic data separately.

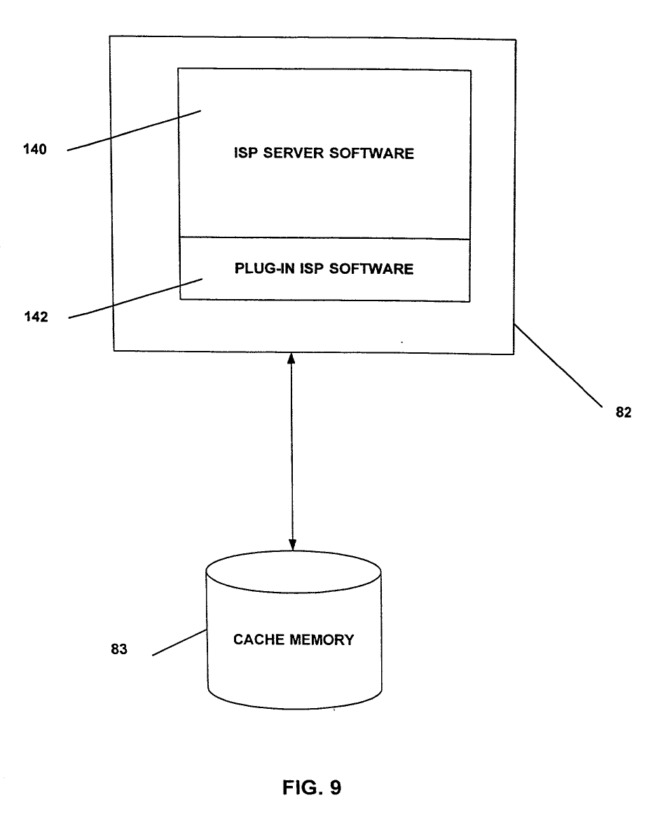

FIG. 9 is an illustration of one embodiment of an intelligent ISP server. In one embodiment the intelligent ISP server 82 includes an ISP operating software 140 that may be 100 percent compatible with the existing technology. Additionally, an add-on or plug-in software component 142 may be added to the ISP server 82 to allow it to receive, process and transmit the new protocol packets based on separate dynamic and static data components. Additionally, an intelligent ISP server 82 may include cache memory 83 that might be used to store the static data portions of the most requested data files.

The cache memory 83 allows at least part of the static data transmitted by a first user to be temporarily stored at that node. This allows for multiple requests received for a particular web page or file to be at least partially fulfilled by the data present in the cach memory. For example, if the file requested by the client includes 100% static data, a second or third client request for that file does not have to travel back to the web server on which the file resides. Since a copy of all static data from the first request for this web page is cached on at least one intelligent device along the route between the intelligent client and the intelligent web server, the intermediate device may be able to supply the requested and fulfill the response without going all the way back to the host web server. Traffic for at least a part of the network is reduced. This scenario may even be implemented in cases of requests coming from traditional clients.

Alternatively, if the file cached at the intermediary node contains both static and dynamic data, the intermediate intelligent machine may send a request for the dynamic data only. If the initial request came from an intelligent client, the intermediate intelligent machine may send dynamic and the static portions of the data in separately. In an alternative embodiment, the intelligent intermediate machine may ascertain whether the static data portions of the requested file are cached at other intelligent intermediate machines along the route between this intelligent machine and the original intelligent client. In that case, the first intelligent machine may only transmit the dynamic portion of the data along to the second intelligent machine. In either scenario, the transferred files are smaller resulting in less traffic congestion on the Internet.

Also, if the original client is not an intelligent client, once the intelligent intermediate machine receives the dynamic components of the file, it combines them into a single file and transmits them according to the existing TCP/IP protocol.

It should be noted that the reductions in traffic resulting from fewer requests and smaller size file transmissions would multiply with the presence of increasing numbers of intelligent machines on the network.

Furthermore, once a first request for a file (e.g. web page) is fulfilled, if the intelligent client requests further updates of the same web page, the request would be for the dynamic data portion of that file only. Since in most cases, the ratio of the dynamic data portion of a typical web page as an example is a lot smaller than the static portion of the data, the amount of the data traveling over the network is reduced. The number of requests and the amount of data requested from the web server may also reduce because intermediary intelligent devices may contain most or all of the data requested and respond to the request.

FIG. 10 is a flow diagram of the operation of one embodiment of an intelligent ISP server. At block 146, the intelligent ISP server 82 receives a file request from a client. At block 148, the ISP server 82 determines if the claim came from an intelligent client 78 or an old technology client 80. At block 150, if the request was initiated by an intelligent client 78, the ISP server checks its cache memory for the availability of the static data to be sent to the intelligent client. The term “Intelligent client” as used here refers to a client that is able to receive data files packets divided into static and dynamic data components and can recreate the complete file by recombining both the static and dynamic data files. At block 154, the ISP server transmits a request for dynamic data to the intelligent file server 86. If the static data is not present in the cache memory, the request transmitted at block 154 would also include a request for the static data. At block 156, the ISP server 82 receives the data that may include both static and dynamic data. At block 158, the ISP server 82 transmits the dynamic and static data to the requesting intelligent client 78.

Alternatively, at block 160, if the request came from client 80, who is not able to process the new protocol based on separate dynamic and static data, the ISP server 82 forwards the request from client 80 to the file server 86. In one embodiment, if the ISP server has the static portions of the requested file in its cache memory 83, is may only forward a request for the dynamic portion of the data relating to the requested file. At block 162, the ISP server receives the dynamic and the static data, if requested. At block 164, the ISP server 82 may recombine the dynamic and static portions of the requested file. At block 166, the ISP server transmits the recombined requested file to the non-intelligent client 80 using the existing transmission protocol.

In one embodiment, the intelligent ISP server 82 may be receiving data files from non-intelligent file servers. The term “intelligent ISP” as used here refers to an ISP server capable of processing data files packets that are divided into their static and dynamic components, by recombining a file from its static and dynamic comoponents. Under that scenario, the ISP server 82 may still be parsing the requested file into its dynamic and static components and transmitting the file as such to its intelligent clients.

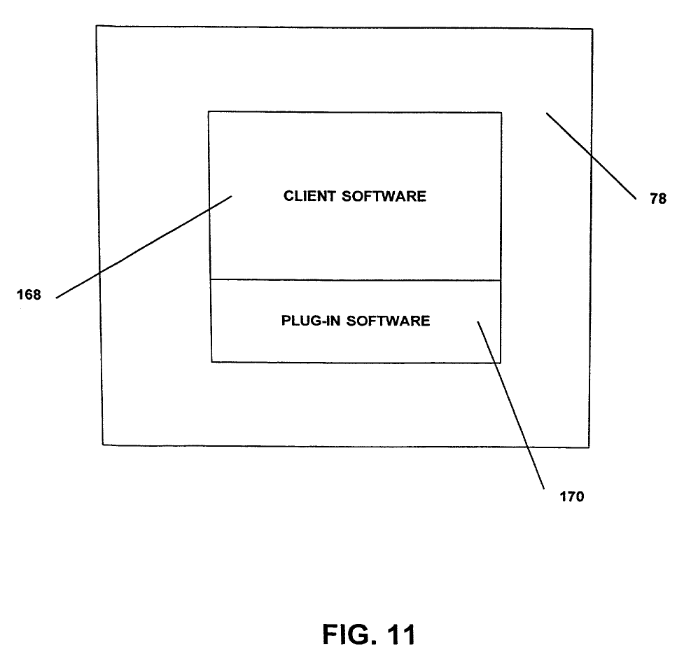

FIG. 11 is an illustration of one embodiment of an intelligent client 78. In one embodiment, the intelligent client machine 78 may include client-operating software 168 based on the existing (old) network protocol, and allowing the client to access the network using this software. In one embodiment, the client-operating software may a web browser allowing the client to access the Internet.

The intelligent client machine 78 may include an add-on or plug-in type of software 170 that enables the intelligent client machine to receive, detect, process and use the new protocol based on the dynamic and static data definitions. This implementation allows for backward compatibility of the intelligent client machine with the existing network and its operating protocol. Furthermore, the plug-in upgrade may allow the conversion of an old type client machine into an intelligent client machine by simply installing a software upgrade.

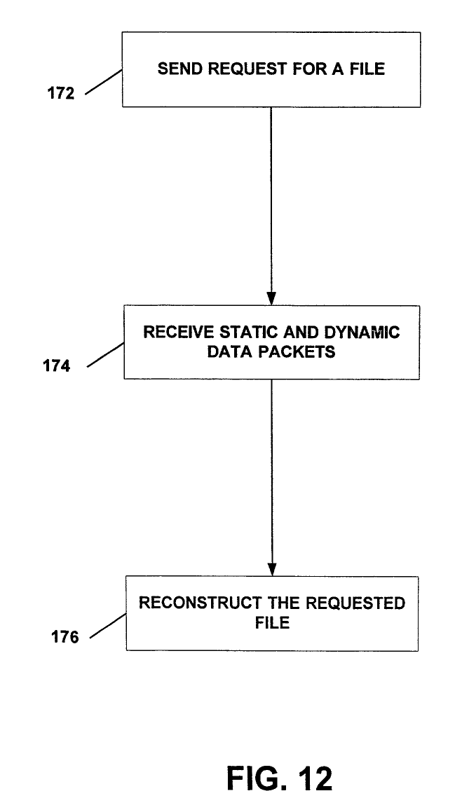

FIG. 12 is a flow diagram of the operation of one embodiment of the intelligent client. At block 172, the intelligent client 78 sends a request for a file to an intelligent server. The request may be partially satisfied at the ISP server as described above. The intelligent client receives the static and dynamic portions of the file at block 174. The client 78 recombines the static and dynamic data packets into the requested file.

In one embodiment, the static data may be broadcast to the intelligent client 78. The plug-in software 170 is capable of capturing and recombining the static data packets that are presented to it by the intelligent ISP server 82, based on a packet-multiplexing table.

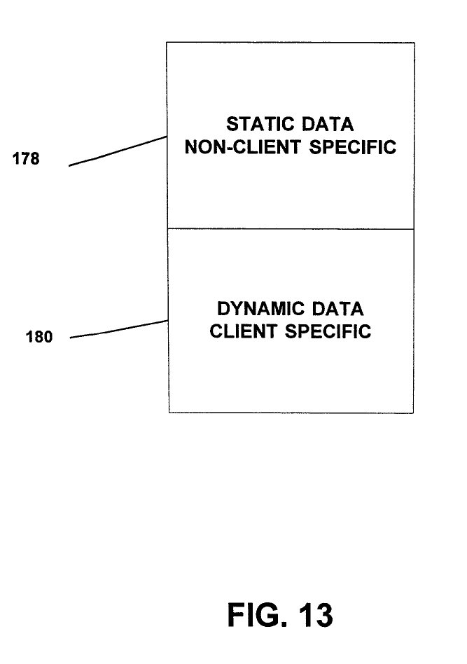

FIG. 13 illustrates the static and dynamic data content of a typical file. A typical requested file 88 such as the one illustrated here may be divided up into its dynamic data components 180 and its static data components 178. As described above, the static data may be defined based on its content and the rate of change of its content over time. This static data 178 is defined as non-client specific since its content does not vary based on the time the client places a request for that data. In contrast, the dynamic data 180 may have content that may change at a much higher rate than the static data and subsequently, at each time the client request is made, the data content may have changed. This data is classified as client specific data. The ratio dynamic data to static data is dependent may vary based on the defined threshold used to divide dynamic and static data.

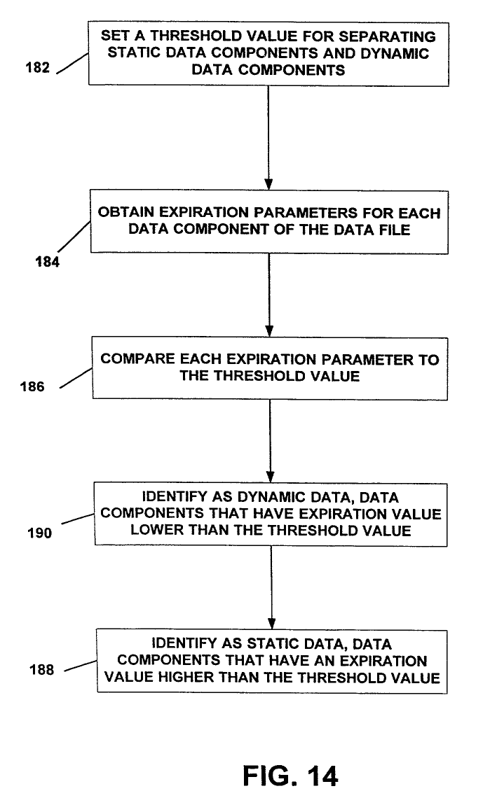

FIG. 14 is a flow diagram for the process of dividing a data file into its dynamic and static components for one embodiment of the present invention. At block 182, a threshold value is set for separating static data components and dynamic data components. The threshold value would be used to compare against an expiration parameter corresponding to each of part of a file. At block 184, the file server 86 may obtain the expiration parameters for each portion of the data in a particular file. At block 186, the file server 86 may compare the expiration parameter for each portion of the data file against the threshold value. At block 190, a dynamic data portion may be identified as the portion of the data file where the corresponding expiration parameter is less than the threshold value of the file server 86. Alternatively, at block 188, if the expiration parameter of that portion of the data is measured to be higher than the threshold value, then that portion of the data may be identified as static data. In one embodiment, the operation of dividing a file into its dynamic and static components may be done offline, prior to receiving a request for that particular file.

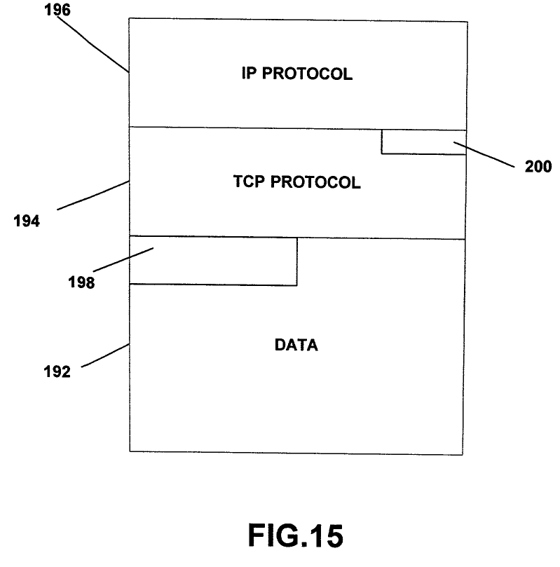

FIG. 15 illustrates a data packet according to one embodiment of the present invention. In one embodiment, an identifying header 198 is added to the data packet 192 providing the information necessary for the operations of the network layer based on Internet Protocol (IP) 196 in identifying and transmitting the packet. Alternatively, the Transport layer protocol TCP 194 may include the addition of a header and/or trailer 200 to it prior to transmission. The new data packet may be distinguished from an old type data packet by inserting identifying information 200 in the (TCP) header 194. The additional bits of data added would be added to locations of the header 194, that is not currently used in the TCP protocol. This enables backward compatibility with existing technology and hardware. The new technology routers, ISP's and clients would be able to use the information inserted 198 or 200 in the TCP header 194 or in the data content 192 in order to recognize a new technology data packet from an old type data packet.

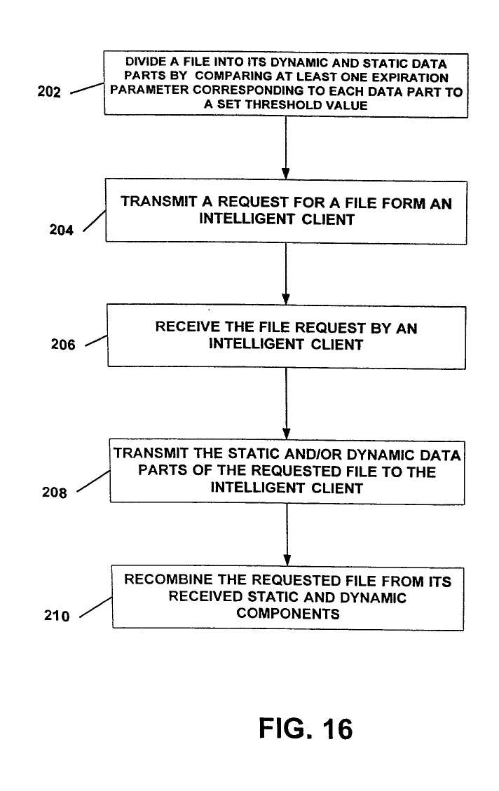

FIG. 16 is a flow diagram of the operation of a system based on one embodiment of the present invention. At block 202, a file is divided up into its dynamic and static data components by comparing at least one expiration parameter corresponding to each data part to a threshold value. The threshold value may be set at the file server based on an analysis of the current load of the server. In one embodiment of the present invention, threshold may be adjusted based on the changing file server traffic. A higher threshold would result in classifying a larger portion of a file as static data, which may result in a lower file server traffic.

At block 204, an intelligent client may transmit a file request to an intelligent server. At block 206, the intelligent file server receives the request from the intelligent client. At block 208, the intelligent file server transmits the static data and/or dynamic data parts of the requested file to the requesting client. In one embodiment of the present invention, the intelligent file server may transmit a copy of the requested file that has not been divided into its static and dynamic components, whenever the file server recognizes that the requesting client is not an intelligent client. In another embodiment, the intelligent file server may start broadcasting the static data components of the requested file once the number of requests for a particular file have exceeded a specified number. At block 210, the intelligent client may receive the requested file and recreate the file by recombining it from its static and dynamic components.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

We claim:

1. A method of parsing a data file into its static and dynamic data components comprising:
setting a threshold value for separating static data components and dynamic data components;
obtaining expiration parameters for each data component of the data file;
comparing each expiration parameter to the threshold value;
identifying as dynamic data components the data components of the data file that have an expiration value lower than the threshold value; and
identifying as static data components the data components of the data file that have an expiration value higher than the threshold value.

2. The method of claim 1 wherein the threshold value is set based on a measurement of a load value of a file server storing the data file.

3. The method of claim 1 wherein the threshold value of a first file server is different than the threshold value of other file servers.

4. A method of sending requested data to a client from an intelligent file server storing a file comprising:
receiving a file request from the client, the file including static data components and dynamic data components;
determining whether the client is intelligent;
dividing static data components into static data packets and dividing dynamic data components into dynamic data packets; and
transmitting the static data packets and the dynamic data packets to an intelligent client.

5. The method of claim 4 wherein the intelligent file server stores in at least one memory location a copy of the requested file and a copy of the requested file divided into its static and dynamic components.

6. The method of claim 4 wherein the intelligent file server stores in at least one memory location a copy of the requested file and creates a copy of the requested file divided into its static and dynamic components and create upon receiving the file request.

7. The method of claim 4 further comprising:
identifying routes between the file server and the intelligent client that include at least one intelligent hardware; and
transmitting the static data components and the dynamic data components using the route that includes at least one intelligent hardware.

8. The method of claim 4 further comprising:
counting the number of requests from intelligent clients for a particular data file;
broadcasting the static data components of said data file to each intelligent client once a number of requests for a particular file surpasses a set value.

9. The method of claim 8 wherein the static data components broadcasting further comprising:
(a) receiving a data file including static data components and dynamic data components;
(b) specifying a time interval;
(c) parsing the static data components into a plurality of static data blocks;
(d) determining a required number of time slots to send the data file,
wherein each of said time slot has a duration substantially equal to said time interval;
(e) allocating to each time slot at least;
(1) a first of said plurality of data blocks; and
(2) optionally one or more additional data blocks, such that said plurality of data blocks is available to a client accessing said data file during any time slot; and
(f) sending said plurality of data blocks based on said allocating step (e).

10. A method for processing data received from an intelligent server comprising:
sending a file request from an intelligent client to the intelligent server, the intelligent server storing a copy of a file divided into its static components and its dynamic components;
receiving static data packets formed by parsing the static data components and dynamic data packets formed by parsing the dynamic data components;
reconstructing the requested file from the received static data packets and dynamic data packets.

11. The method of claim 10 including the step of receiving static data from a broadcast, further comprising:
(a) receiving a selection of a data file during a first time slot;
(b) receiving at least one data block of said data file during a second time slot; and
(c) during a next time slot:
(1) receiving any data block not already received;
(2) recombining the received data blocks to form the data file; and
(3) repeating step (c) until all data blocks of said data file have been received and recombined.

12. The method of claim 11 wherein further comprising:
performing an error check; and
sending a request to resend the data blocks generating the error check.

13. The method of claim 11 wherein the step of recombining of the data blocks does not start until after all the data files have been received.

14. A method of creating an intelligent protocol data packet comprising:
including identifying information identifying the intelligent data protocol.

15. The method of claim 14 wherein said identification information is included in a header portion of the data packet.

16. The method of claim 15 wherein the data packet is created based on TCP/IP protocol.

17. The method of claim 16 wherein the header portion is the TCP information portion.

18. The method of claim 14 wherein said identification information is included in the data portion of the data packet.

19. The method of claim 18 wherein the data packet is created based on TCP/IP protocol.

20. A method of servicing a data request to a file server from a client connected to the network through a network connection providing server comprising:
receiving a request for a file from the client directed to the file server;
forwarding the request to the file server;
receiving the data from the file server;
storing a copy of a static portions of the received data;
transmitting at least a dynamic data portion of the received data to the client.

21. The method of claim 20 further comprising:
checking a memory related to the network connection providing server for the presence of a first group of data corresponding to the static portions of the requested file;
determining whether the file server is an intelligent file server;
sending the first group of data to the client;
sending a request to the file server for a second group of data not saved in the memory;
receiving the second group of data from the file server; and
sending at least the second group of data to the client.

22. A method of responding to a file request from an intelligent client by an intelligent network connection providing server comprising:
receiving a file request from a client;
determining if the client is intelligent;
sending a static data to the intelligent client;
forwarding a request for at least a dynamic data related to the requested file to an intelligent server storing the requested file;
receiving at least the dynamic data; and
transmitting at least the dynamic data to the client.

23. The method of claim 22 wherein the client is not intelligent, further comprising:
recombining the received static data for the requested file and the received dynamic data for the requested file; and
repacketing the requested file before transmitting the requested file to the client.

24. The method of claim 22 further comprising:
counting a number of requests from intelligent clients for a particular data file;
broadcasting the static data for the requested file once the number of requests for a particular file surpasses a set value.

25. The method of claim 24 wherein broadcasting the static data further comprising:
(a) specifying a time interval;
(b) parsing the static data into a plurality of static data blocks;
(c) determining a required number of time slots to send the static data,
wherein each of said time slot has a duration substantially equal to said time interval;
(d) allocating to each time slot at least;
(1) a first of the plurality of static data blocks; and
(2) optionally one or more additional static data blocks; and
(e) sending the plurality of static data blocks based on said allocating step (d).

26. A method of operation for a system for transmitting and receiving data within a network comprising:
dividing a file into dynamic data and static data by comparing at least one expiration parameter corresponding to each data part to a set threshold value;
transmitting a request for a file from an intelligent client;
receiving the file request by an intelligent server;
transmitting at least the dynamic data components of the requested file to the intelligent client; and
recombining the static components and the dynamic components of the requested file.

27. The method of claim 26 further comprising:
identifying routes between the intelligent file server and the intelligent client that include at least one intelligent hardware; and
transmitting the static data components and the dynamic data components using the route that includes at least one intelligent hardware.

28. The method of claim 26 further comprising:
counting the number of requests from intelligent clients for a particular data file;
broadcasting the static data components of said data file to each intelligent client once a number of request for a particular file surpasses a set value.

29. The method of claim 28 wherein the static data broadcasting steps further comprises:
(a) receiving a static data blocks of a data file;
(b) specifying a time interval;
(c) parsing said data file into a plurality of data blocks based on said time interval such that each data block is displayable during said time interval;
(d) determining a required number of time slots to send said data file, wherein each of said time slot has a duration substantially equal to said time interval;
(e) allocating to each time slot at least;
(1) a first of said plurality of data blocks; and
(2) optionally one or more additional data blocks, such that said plurality of data blocks is available in sequential order to a client accessing said data file during any time slot; and
(f) sending said plurality of data blocks based on said allocating step (e).

30. The method of claim 26 wherein the intelligent file server stores a copy of the requested file separated into its static data components and its dynamic data components and a copy of the requested file that is not separated into its dynamic data components and static data components.

31. A method of sending a file over a network from an originating node to a requesting client, comprising:
receiving a request for the file at an intermediate node;
providing a time insensitive component of the file to the client from the intermediate node; and
providing a time sensitive component of the file to the client from the originating node.

32. The method of claim 31 further comprising:
determining whether or not components of a file are time sensitive or time insensitive based on a comparison between a threshold value and a defined time value for each of the components.

33. The method of claim 32 wherein the threshold value is dependent on the load of the originating server.

34. The method of claim 31 further comprising the steps of:
determining at the intermediate node whether or not the client is adapted to receive time insensitive and time sensitive components; and if the client is not so adapted,
assembling the file from the time sensitive and time insensitive components at the intermediate node; and
transmitting the assembled file to the client from the intermediate node.

35. A computer program product embodied in a computer readable medium for parsing a data file into its static and dynamic data components comprising:
code means for setting a threshold value for separating static data components and dynamic data components;
code means for obtaining expiration parameters for each data component of the data file;
code means for comparing each expiration parameter to the threshold value;
code means for identifying as dynamic data components the data components of the data file that have an expiration value lower than the threshold value; and
code means for identifying as static data components the data components of the data file that have an expiration value higher than the threshold value.

36. The computer program product of claim 35 wherein the threshold value is set based on a measurement of a load value of a file server storing the data file.

37. The computer program product of claim 35 wherein the threshold value of a first file server is different than the threshold value of other file servers.

38. A computer program product embodied in a computer readable medium for sending requested data to a client from an intelligent file server storing a file comprising:
code means for receiving a file request from the client, the file including static data components and dynamic data components;
code means for determining whether the client is intelligent;
code means for dividing static data components into static data packets and dividing dynamic data components into dynamic data packets; and
code means for transmitting the static data packets and the dynamic data packets to an intelligent client.

39. The computer program product of claim 38 wherein the intelligent file server stores in at least one memory location a copy of the requested file and a copy of the requested file divided into its static and dynamic components.

40. The computer program product of claim 38 wherein the intelligent file server stores in at least one memory location a copy of the requested file and creates a copy of the requested file divided into its static and dynamic components and create upon receiving the file request.

41. The computer program product of claim 38 further comprising:
code means for identifying routes between the file server and the intelligent client that include at least one intelligent hardware; and
code means for transmitting the static data components and the dynamic data components using the route that includes at least one intelligent hardware.

42. The computer program product of claim 38 further comprising:
code means for counting the number of requests from intelligent clients for a particular data file;
code means for broadcasting the static data components of said data file to each intelligent client once a number of requests for a particular file surpasses a set value.

43. The computer program product of claim 42 wherein the static data components broadcasting further comprising:
(a) code means for receiving a data file including static data components and dynamic data components;
(b) code means for specifying a time interval;
(c) parsing the static data components into a plurality of static data blocks;
(d) code means for determining a required number of time slots to send the data file, wherein each of said time slot has a duration substantially equal to said time interval;
(e) code means for allocating to each time slot at least;
(1) a first of said plurality of data blocks; and
(2) optionally one or more additional data blocks, such that said plurality of data blocks is available to a client accessing said data file during any time slot; and
(f) code means for sending said plurality of data blocks based on said allocating step (e).

44. A computer program product embodied in a computer readable medium for processing data received from an intelligent server comprising:
code means for sending a file request from an intelligent client to the intelligent server, the intelligent server storing a copy of a file divided into its static components and its dynamic components;
code means for receiving static data packets formed by parsing the static data components and dynamic data packets formed by parsing the dynamic data components;
code means for reconstructing the requested file from the received static data packets and dynamic data packets.

45. The computer program product of claim 44 including the step of receiving static data from a broadcast, further comprising:
(a) code means for receiving a selection of a data file during a first time slot;
(b) code means for receiving at least one data block of said data file during a second time slot; and
(c) during a next time slot:
(1) code means for receiving any data block not already received;
(2) code means for recombining the received data blocks to form the data file; and
(3) code means for repeating step (c) until all data blocks of said data file have been received and recombined.

46. The computer program product of claim 45 wherein further comprising:
code means for performing an error check; and
code means for sending a request to resend the data blocks generating the error check.

47. The computer program product of claim 45 wherein the step of recombining of the data blocks does not start until after all the data files have been received.

48. A computer program product embodied in a computer readable medium for creating an intelligent protocol data packet comprising:
code means for identifying information identifying the intelligent data protocol.

49. The computer program product of claim 48 wherein said identification information is included in a header portion of the data packet.

50. The computer program product of claim 49 wherein the data packet is created based on TCP/IP protocol.

51. The computer program product of claim 50 wherein the header portion is the TCP information portion.

52. The computer program product of claim 48 wherein said identification information is included in the data portion of the data packet.

53. The computer program product of claim 52 wherein the data packet is created based on TCP/IP protocol.

54. A computer program product embodied in a computer readable medium for servicing a data request to a file server from a client connected to the network through a network connection providing server comprising:
code means for receiving a request for a file from the client directed to the file server;
code means for forwarding the request to the file server;
code means for receiving the data from the file server;
code means for storing a copy of a static portions of the received data;
code means for transmitting at least a dynamic data portion of the received data to the client.

55. The computer program product of claim 54 further comprising:
code means for checking a memory related to the network connection providing server for the presence of a first group of data corresponding to the static portions of the requested file;
code means for determining whether the file server is an intelligent file server;
code means for sending the first group of data to the client;
code means for sending a request to the file server for a second group of data not saved in the memory;
code means for receiving the second group of data from the file server; and
code means for sending at least the second group of data to the client.

56. A computer program product embodied in a computer readable medium for responding to a file request from an intelligent client by an intelligent network connection providing server comprising:
code means for receiving a file request from a client;
code means for determining if the client is intelligent;
code means for sending a static data to the intelligent client;
code means for forwarding a request for at least a dynamic data related to the requested file to an intelligent server storing the requested file;
code means for receiving at least the dynamic data; and
code means for transmitting at least the dynamic data to the client.

57. The computer program product of claim 56 wherein the client is not intelligent and further comprising:
code means for recombining the received static data for the requested file and the received dynamic data for the requested file; and
code means for repacketing the requested file before transmitting the requested file to the client.

58. The computer program product of claim 56 further comprising:
code means for counting a number of requests from intelligent clients for a particular data file;
code means for broadcasting the static data for the requested file once the number of requests for a particular file surpasses a set value.

59. The computer program product of claim 58 wherein broadcasting the static data further comprising:
(a) code means for specifying a time interval;
(b) code means for parsing the static data into a plurality of static data blocks;
(c) code means for determining a required number of time slots to send the static data, wherein each of said time slot has a duration substantially equal to said time interval;
(d) code means for allocating to each time slot at least;
(1) a first of the plurality of static data blocks; and
(2) optionally one or more additional static data blocks; and
(e) code means for sending the plurality of static data blocks based on said allocating step (d).

60. A computer program product embodied in a computer readable medium for operation of a system for transmitting and receiving data within a network comprising:
code means for dividing a file into dynamic data parts and static data parts by comparing at least one expiration parameter corresponding to each data part to a set threshold value;
code means for transmitting a request for a file from an intelligent client;
code means for receiving the file request by an intelligent server;
code means for transmitting at least the dynamic data components of the requested file to the intelligent client; and
code means for recombining the static components and the dynamic components of the requested file.

61. The computer program product of claim 60 further comprising:
code means for identifying routes between the intelligent file server and the intelligent client that include at least one intelligent hardware; and
code means for transmitting the static data components and the dynamic data components using the route that includes at least one intelligent hardware.

62. The computer program product of claim 60 further comprising:
code means for counting the number of requests from intelligent clients for a particular data file;
code means for broadcasting the static data components of said data file to each intelligent client once a number of request for a particular file surpasses a set value.

63. The computer program product of claim 62 wherein the static data broadcasting steps further comprises:
(a) code means for receiving a static data blocks of a data file;
(b) code means for specifying a time interval;
(c) code means for parsing said data file into a plurality of data blocks based on said time interval such that each data block is displayable during said time interval;
(d) code means for determining a required number of time slots to send said data file, wherein each of said time slot has a duration substantially equal to said time interval;
(e) code means for allocating to each time slot at least;
(1) a first of said plurality of data blocks; and
(2) optionally one or more additional data blocks, such that said plurality of data blocks is available in sequential order to a client accessing said data file during any time slot; and
(f) code means for sending said plurality of data blocks based on said allocating step (e).

64. The program method program of claim 60 wherein the intelligent file server stores a copy of the requested file separated into its static data components and its dynamic data components and a copy of the requested file that is not separated into its dynamic data components and static data components.

65. A computer program product embodied in a computer readable medium for sending a file over a network from an originating node to a requesting client, comprising:
code means for embodied in a computer readable medium for receiving a request for the file at an intermediate node;
code means for providing a time insensitive component of the file to the client from the intermediate node; and
code means for providing a time sensitive component of the file to the client from the originating node.

66. The computer program product of claim 65 further comprising:
code means for determining whether or not components of a file are time sensitive or time insensitive based on a comparison between a threshold value and a defined time value for each of the components.

67. The computer program product of claim 66 wherein the threshold value is dependent on the load of the originating server.

68. The computer program product of claim 65 further comprising the steps of:
code means for determining at the intermediate node whether or not the client is adapted to receive time insensitive and time sensitive components; and
if the client is not so adapted,
code means for assembling the file from the time sensitive and time insensitive components at the intermediate node; and
code means for transmitting the assembled file to the client from the intermediate node.

69. An apparatus for parsing a data file into its static and dynamic data components comprising:
means for setting a threshold value for separating static data components and dynamic data components;
means for obtaining expiration parameters for each data component of the data file;
means for comparing each expiration parameter to the threshold value;
means for identifying as dynamic data components the data components of the data file that have an expiration value lower than the threshold value; and
means for identifying as static data components the data components of the data file that have an expiration value higher than the threshold value.

70. The apparatus of claim 69 wherein the threshold value is set based on a measurement of a load value of a file server storing the data file.

71. The apparatus of claim 69 wherein the threshold value of a first file server is different than the threshold value of other file servers.

72. An apparatus for sending requested data to a client from an intelligent file server storing a file comprising:
means for receiving a file request from the client, the file including static data components and dynamic data components;
means for determining whether the client is intelligent;
means for dividing static data components into static data packets and dividing dynamic data components into dynamic data packets; and
means for transmitting the static data packets and the dynamic data packets to an intelligent client.

73. The apparatus of claim 72 wherein the intelligent file server stores in at least one memory location a copy of the requested file and a copy of the requested file divided into its static and dynamic components.

74. The apparatus of claim 72 wherein the intelligent file server stores in at least one memory location a copy of the requested file and creates a copy of the requested file divided into its static and dynamic components and create upon receiving the file request.

75. The apparatus of claim 72 further comprising:
means for identifying routes between the file server and the intelligent client that include at least one intelligent hardware; and
means for transmitting the static data components and the dynamic data components using the route that includes at least one intelligent hardware.

76. The apparatus of claim 72 further comprising:
means for counting the number of requests from intelligent clients for a particular data file;
means for broadcasting the static data components of said data file to each intelligent client once a number of requests for a particular file surpasses a set value.

77. The method of claim 76 wherein the static data components broadcasting further comprising:
(a) means for receiving a data file including static data components and dynamic data components;
(b) means for specifying a time interval;
(c) means for parsing the static data components into a plurality of static data blocks;
(d) means for determining a required number of time slots to send the data file, wherein each of said time slot has a duration substantially equal to said time interval;
(e) means for allocating to each time slot at least;
(1) a first of said plurality of data blocks; and
(2) optionally one or more additional data blocks, such that said plurality of data blocks is available to a client accessing said data file during any time slot; and
(f) means for sending said plurality of data blocks based on said allocating step (e).

78. An apparatus for processing data received from an intelligent server comprising:
means for sending a file request from an intelligent client to the intelligent server, the intelligent server storing a copy of a file divided into its static components and its dynamic components;
means for receiving static data packets formed by parsing the static data components and dynamic data packets formed by parsing the dynamic data components;
means for reconstructing the requested file from the received static data packets and dynamic data packets.

79. The apparatus of claim 78 including the step of receiving static data from a broadcast, further comprising:
(a) means for receiving a selection of a data file during a first time slot;
(b) means for receiving at least one data block of said data file during a second time slot; and
(c) during a next time slot:
(1) means for receiving any data block not already received;
(2) means for recombining the received data blocks to form the data file; and
(3) means for repeating step (c) until all data blocks of said data file have been received and recombined.

80. The apparatus of claim 79 wherein further comprising:
means for performing an error check; and
means for sending a request to resend the data blocks generating the error check.

81. The apparatus of claim 79 wherein the step of recombining of the data blocks does not start until after all the data files have been received.

82. An apparatus for creating an intelligent protocol data packet comprising:
means for including identifying information identifying the intelligent data protocol.

83. The apparatus of claim 82 wherein said identification information is included in a header portion of the data packet.

84. The apparatus of claim 83 wherein the data packet is created based on TCP/IP protocol.

85. The apparatus of claim 84 wherein the header portion is the TCP information portion.

86. The apparatus of claim 82 wherein said identification information is included in the data portion of the data packet.

87. The apparatus of claim 86 wherein the data packet is created based on TCP/IP protocol.

88. An apparatus for servicing a data request to a file server from a client connected to the network through a network connection providing server comprising:
means for receiving a request for a file from the client directed to the file server;
means for forwarding the request to the file server;
means for receiving the data from the file server;
means for storing a copy of a static portions of the received data;
means for transmitting at least a dynamic data portion of the received data to the client.

89. The apparatus of claim 88 further comprising:
means for checking a memory related to the network connection providing server for the presence of a first group of data corresponding to the static portions of the requested file;
means for determining whether the file server is an intelligent file server;
means for sending the first group of data to the client;
means for sending a request to the file server for a second group of data not saved in the memory;
means for receiving the second group of data from the file server; and
means for sending at least the second group of data to the client.

90. An apparatus for responding to a file request from an intelligent client by an intelligent network connection providing server comprising:
means for receiving a file request from a client;
means for determining if the client is intelligent;
means for sending a static data to the intelligent client;
means for forwarding a request for at least a dynamic data related to the means for requested file to an intelligent server storing the requested file;
means for receiving at least the dynamic data; and
means for transmitting at least the dynamic data to the client.

91. The apparatus for claim 90 wherein the client is not intelligent, further comprising:
means for recombining the received static data for the requested file and the received dynamic data for the requested file; and
means for repacketing the requested file before transmitting the requested file to the client.

92. The apparatus for claim 90 further comprising:
means for counting a number of requests from intelligent clients for a particular data file;
means for broadcasting the static data for the requested file once the number of requests for a particular file surpasses a set value.

93. The apparatus of claim 92 wherein broadcasting the static data further comprising:
(a) means for specifying a time interval;
(b) means for parsing the static data into a plurality of static data blocks;
(c) means for determining a required number of time slots to send the static data, wherein each of said time slot has a duration substantially equal to said time interval;
(d) means for allocating to each time slot at least;
(1) a first of the plurality of static data blocks; and
(2) optionally one or more additional static data blocks; and
(e) means for sending the plurality of static data blocks based on said allocating step (d).

94. An apparatus for the operation of a system for transmitting and receiving data within a network comprising:
means for dividing a file into dynamic data and static data by comparing at least one expiration parameter corresponding to each data part to a set threshold value;
means for transmitting a request for a file from an intelligent client;
means for receiving the file request by an intelligent server;
means for transmitting at least the dynamic data components of the requested file to the intelligent client; and
means for recombining the static components and the dynamic components of the requested file.

95. The apparatus of claim 94 further comprising:
means for identifying routes between the intelligent file server and the intelligent client that include at least one intelligent hardware; and
means for transmitting the static data components and the dynamic data components using the route that includes at least one intelligent hardware.

96. The apparatus of claim 94 further comprising:
means for counting the number of requests from intelligent clients for a particular data file;
means for broadcasting the static data components of said data file to each intelligent client once a number of request for a particular file surpasses a set value.

97. The apparatus of claim 96 wherein the static data broadcasting steps further comprises:
(a) means for receiving a static data blocks of a data file;
(b) means for specifying a time interval;
(c) means for parsing said data file into a plurality of data blocks based on said time interval such that each data block is displayable during said time interval;
(d) means for determining a required number of time slots to send said data file, wherein each of said time slot has a duration substantially equal to said time interval;
(e) means for allocating to each time slot at least;
(1) a first of said plurality of data blocks; and
(2) optionally one or more additional data blocks, such that said plurality of data blocks is available in sequential order to a client accessing said data file during any time slot; and
(f) means for sending said plurality of data blocks based on said allocating step (e).

98. The apparatus for claim 94 wherein the intelligent file server stores a copy of the requested file separated into its static data components and its dynamic data components and a copy of the requested file that is not separated into its dynamic data components and static data components.

99. An apparatus for sending a file over a network from an originating node to a requesting client, comprising:
means for receiving a request for the file at an intermediate node;
means for providing a time insensitive component of the file to the client from the intermediate node; and
means for providing a time sensitive component of the file to the client from the originating node.

100. The apparatus of claim 99 further comprising:
means for determining whether or not components of a file are time sensitive or time insensitive based on a comparison between a threshold value and a defined time value for each of the components.

101. The apparatus of claim 100 wherein the threshold value is dependent on the load of the originating server.

102. The apparatus of claim 99 further comprising the steps of:
means for determining at the intermediate node whether or not the client is adapted to receive time insensitive and time sensitive components; and
if the client is not so adapted,
means for assembling the file from the time sensitive and time insensitive components at the intermediate node; and means for transmitting the assembled file to the client from the intermediate node.

103. A broadcast server method of transmitting data files, comprising the acts of:
providing a data file consisting of static data and dynamic data;
parsing said data file into a static data component and at least one dynamic data component;
transmitting said static data component and said at least one dynamic component via a transmission medium such that said static component and said at least one dynamic component may be displayed visually; and
transmitting at least one additional dynamic component that supercedes said at least one dynamic component via said transmission medium such that said at least one additional dynamic component may be displayed with said static component, wherein said additional dynamic component is displayed in place of said at least one dynamic component.

104. A method as recited in claim 103, wherein said act of parsing said data file includes determining whether each component of said data file is a static component or a dynamic component.

105 A method as recited in claim 104, wherein each component of said data file has an expiration value, and wherein said determination is made in response to said expiration value.

106. A method as recited in claim 105, wherein components having an expiration value greater than a predetermined threshold value are determined to be static components and components having an expiration value less than said predetermined threshold value are determined to be dynamic components.

107. A method as recited in claim 105, wherein said static components are divided into static data packets and dynamic components are divided into dynamic data packets for transmission.

108. A method as recited in claim 107, wherein each data packet has a header containing information indicating whether said data packet is a static data packet or a dynamic data packet.

109. A method as recited in claim 105, wherein said static and dynamic data components are transmitted in a scheduling sequence at least partially responsive to said expiration values.

110. A method as recited in claim 109, wherein data components having higher expiration values are transmitted more often than data components having lower expiration values.

111. A method as recited in claim 109, wherein said static data is transmitted to a plurality of users, and wherein said additional dynamic data component is transmitted to a subgroup of said plurality of users, thereby providing a display having a generic static component and a dynamic component unique to said subgroup.

112. A method for displaying data files having static and dynamic components received from a broadcast server, comprising the acts of:
receiving static data blocks containing portions of a static image;
receiving dynamic data blocks containing portions of a plurality of dynamic images;
combining said static and dynamic images over a plurality of time intervals, wherein at each time interval said static image is combined with a dynamic image, thereby forming a display having both dynamic and static components.

113. A method as recited in claim 112, wherein said received static image is stored in a first memory location and displayed from said memory location.

114. A method as recited in claim 112, further comprising the acts of:
sending a file request to a broadcast server; and
receiving said file parsed as said dynamic and static data blocks.

115. A method as recited in claim 112, wherein said dynamic images are stored in a second memory location and displayed from memory, wherein the most recently received dynamic images are displayed.

116. A method as recited in claim 115, wherein said static images are stored in a first memory location and displayed from memory, wherein the most recently received static image is displayed.
